(19) United States
(12) Patent Application Publication
(10) Pub. No.: US 2004/0039582 A1
(43) Pub. Date: Feb. 26, 2004

(54) Method for securing patent protection in developed countries by inventors in developing countries

(76) Inventor: Raj S. Dave, Gaithersburg, MD (US)

Correspondence Address: Raj S. Dave, Ph.D., J.D, 107 Alderwood Drive, Gaithersburg, MD, 20006-1888, US

(21) Appl. No.: 10/227,510

(22) Filed: Aug. 26, 2002

(51) Int. Cl. G06F 17/60

(52) U.S. Cl. 705/1

(57) ABSTRACT

A method for securing patent protection in the United States by an inventor in developing country using a mutually beneficial royalty sharing scheme between the inventor and a party having exclusive rights to prosecute the foreign inventor's patent application in the United States and to the patent granted on the application is disclosed. More specifically, the invention relates to protection afforded to small entities such as universities and small inventors.

### FIELD OF INVENTION

The invention relates to a method for securing patent protection in developed countries by inventors in developing countries. More specifically, the invention relates to protection afforded to small entities such as universities and small inventors.

### BACKGROUND OF INVENTION

Globalization presents tremendous opportunities in several niche areas. Securing patents is one such segment for many competent technologists.

From patent law viewpoint, it does not matter where (geography) a product is designed—the underlying idea would be patented where the markets and manufacturing bases are. Thus, the products (both hardware and software) designed in developing countries such as India and China could be patented in industrialized areas such as the United States, Europe, Japan, Taiwan and Korea, and this is the normal practice of multi-national companies.

Given the increasing research activities in the developing countries and the potential for huge revenue from the activities, any inventor addressing global markets is often forced to patent the technology globally outside of India if the inventor can afford to pay for the cost of prosecution in developed countries or lose patent rights. The cost to prosecute and obtain a patent in the United States claiming priority from a foreign patent application is around $5,000-15,000. This cost is causing a tremendous strain on the inventors in developing countries such as India and China and, therefore, limiting the demand for United States filing of Indian and Chinese origin applications even though India and China scientists are preeminent in some technologies such as information technology (IT) and biotechnology.

The potential increase in patenting activity can be appreciated by comparing the number of United States patents originating from India and China. The United States is a good place to compare because products are often designed in India with a view to marketing them first in the United States. According to a report entitled “Patenting Trends, Calendar Year 1999,” published by the United States Patent and Trademark Office (USPTO), a total of about 140,000 patents issued in 1999. Of those, about 70,000 patents originated from the United States, about 30,000 from Japan, about 10,000 from Germany, and about 4,000 from each of Taiwan, France, United Kingdom, South Korea and Canada. Only 99 and 114 patents originated from China and India, respectively, which combined together have nearly half the world's population, and possibly half the world's engineers and scientists.

With the design and research services proliferating increasingly in India and China, the number of patents originating from India and China could be substantially higher going forward. As prosecuting and obtaining each patent application in IT and other areas usually costs several thousands of United States dollars, the increase in market opportunity could be stifled unless there is a method by which the inventors in the third world countries could obtain patent protection without the upfront cost of prosecuting and obtaining a patent in the United States. In addition, the United States laws and practice are unique and highly demanding. As a result, many inventors from developing countries are discouraged from obtaining patent protection in the United States.

### SUMMARY OF THE INVENTION

One embodiment of this invention is a method for obtaining patent protection in the United States on an invention from a foreign country, comprising filing a foreign patent application in the foreign country, granting to an exclusive right holder (a) a right to prosecute a United States application claiming priority from the foreign patent application and (b) a right to a patent granted on the United States application, granting a right to the inventive entity to share a royalty payment from the patent and prosecuting the United States application by the exclusive right holder.

Another embodiment is a method for obtaining patent protection in the United States on an invention from a foreign country, comprising granting to an exclusive right holder (a) a right to prosecute a United States application claiming the invention and (b) a right to a patent granted on the United States application, granting a right to the inventive entity to share a royalty payment from the patent and prosecuting the United States application by the exclusive right holder.

As will be realized, this invention is capable of other and different embodiments, and its details are capable of modifications in various obvious respects, all without departing from this invention. Accordingly, the description is to be regarded as illustrative in nature and not as restrictive.

### DESCRIPTION OF THE INVENTION

This invention provides a method for securing patent protection in a developed country, particularly, the United States, by inventors in developing countries. Briefly, the proposed method is the following.

The term “inventive entity” refers to either a person who makes an invention in a foreign country or an organization in a foreign country to whom the person assigns the invention. The term “exclusive right holder” refers to a party to whom the inventive entity grants an exclusive license or an assignment in the United States on the invention itself and all United States patents granted on the invention. The term “foreign country” is a country other than the United States.

In one embodiment, after an inventive entity files a local application in a developing country such as India or China (or even before filing the local application), the inventive entity grants an exclusive license in the patent application and the patents granted on the application to an exclusive right holder in the United States (or maybe, world-wide other than the country of origin of the inventive entity). The exclusive right holder prosecutes the counterpart United States application claiming priority from the local (Indian or Chinese, for example) application (or a PCT application filed in the country of origin of the inventive entity). In return for the exclusive license, the exclusive right holder agrees to pay for substantially all the cost for prosecuting and obtaining the United States patents granted on the application, to prosecute potential infringers of the patents and to share the royalty generated from the patents with inventive entity.

In another embodiment, the inventive entity does not file a patent application in the country of origin of the inventive entity, but directly first files an application (provisional or non-provisional) in the United States.

In yet, another embodiment, the inventive entity first files a PCT application and subsequently the inventive entity or exclusive right holder files a Unites States provisional application within 12 months after filing the PCT application containing substantially the same disclosure as that of the PCT application but without claiming priority from the PCT application. Subsequently, the exclusive right holder files a non-provisional application within 12 months after filing the provisional application claiming priority from both the PCT and provisional applications.

A patent grants a right to exclude others from making and selling a claimed invention. From the exclusive right holder's perspective, an exclusive license is effectively the same as an assignment in terms of the exclusive right holder's ability to prosecute potential infringers. The exclusive right holder freely enforces the licensed patents in the United States against a potential infringer without the approval of the inventive entity.

What would be the cost to the exclusive right holder? It would be about $10,000 to prosecute the application and obtain a patent from the USPTO. Assume, that a licensee decides to prosecute 20 patent applications per year. This would mean a cost of about $200,000 per year and about $1 million in 5 years. However, in return the exclusive right holder would have exclusive licenses or assignments to about 100 patents in 5-7 year period. Assume that only 1 or 2 of these 100 patents turn out to be blockbusters and a few are less than blockbuster, but do generate some revenue. Under this scenario, during the lifetime of the 100 patents, the exclusive right holder would likely recover much more than $1 million spent over the 5 years period in prosecuting the 100 patent applications. In particular, if a product infringes a patent then the royalty income in the United States at a typical royalty rate of 2-3% of the gross price can be quite high depending on the volume of sales.

The claimed method creates tremendous opportunity to set up royalty-sharing arrangement between universities and companies in developing countries such as India and China and exclusive right holders in the United States. Currently, many inventions are being made in the developing countries, but nobody in the United States even hears about them because there is no protection available on these inventions. Also, effectively by implementing the above proposal, the exclusive right holder could “own” several research centers throughout the world with very little investment. The claimed method could be implemented under a program of the World Bank and/or other agencies that provides grants to fund a program to promote patenting of inventions from developing countries. Furthermore, the inventors from developing countries would have access to the United States market to license their inventions and sell technologies related to the inventions.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations. Persons skilled in the art would recognize that the numerical ranges disclosed inherently support any range within the disclosed numerical ranges even though a precise range limitation is not started verbatim in the specification because this invention can be practiced throughout the disclosed numerical ranges. A holding to the contrary would “let form triumph over substance” and allow the written description requirement to eviscerate claims that might be narrowed during prosecution simply because the applicants broadly disclose in this application but then might narrow their claims during prosecution. Finally, the entire disclosure of the priority documents, patents and publications referred in this application are hereby incorporated herein by reference.

1. A method for obtaining patent protection in the United States on an invention from a foreign country, comprising:
filing a foreign patent application in the foreign country,
granting to an exclusive right holder (a) a right to prosecute a United States application claiming priority from the foreign patent application and (b) a right to a patent granted on the United States application,
granting a right to the inventive entity to share a royalty payment from the patent and
prosecuting the United States application by the exclusive right holder.

2. A method for obtaining patent protection in the United States on an invention from a foreign country, comprising:
granting to an exclusive right holder (a) a right to prosecute a United States application claiming the invention and (b) a right to a patent granted on the United States application,
granting a right to the inventive entity to share a royalty payment from the patent and
prosecuting the United States application by the exclusive right holder.

3. The method of claim 1, wherein the foreign country is a country other than Germany, United Kingdom and Japan.

4. The method of claim 1, wherein the foreign country is China or India.

5. The method of claim 1, wherein said inventive entity at the time of said granting a right to prosecute a United States application is an independent inventor, an organization hiring less than 500 people or a non-profit organization.

6. The method of claim 5, wherein the non-profit organization is a university.

7. The method of claim 1, wherein the exclusive right holder agrees to prosecute potential infringers of the patent.

8. The method of claim 1, wherein said right to a patent granted on the United States application is an exclusive license.

9. The method of claim 1, wherein said right to a patent granted on the United States application is an assignment.

10. The method of claim 1, wherein said right to prosecute a United States application claiming the invention is a right to file and prosecute a single patent application or multiple patent applications related to the invention at the United States Patent and Trademark Office.

11. The method of claim 1, wherein the exclusive right holder pays substantially all of the cost of prosecuting the United States application at the United States Patent and Trademark Office.

12. The method of claim 1, wherein the royalty payment comprises money.

13. The method of claim 1, wherein the royalty payment comprises a license to a patent granted or assigned to a party other than the inventive entity.

14. The method of claim 1, wherein the inventive entity first files a PCT application and subsequently the inventive entity or exclusive right holder files a United States provisional application within 12 months after filing the PCT application containing substantially the same disclosure as that of the PCT application but without claiming priority from the PCT application.

15. The method of claim 1, wherein the exclusive right holder enforces the patent against a potential infringer without an approval of the inventive entity.

16. The method of claim 1, wherein the method is implemented at least partially under a program of an agency that provides funds to promote patenting of inventions from foreign countries.

17. The method of claim 2, wherein the foreign country is a country other than Germany, United Kingdom and Japan.

18. The method of claim 2, wherein the foreign country is China or India.

19. The method of claim 2, wherein said inventive entity at the time of said granting a right to prosecute a United States application is an independent inventor, an organization hiring less than 500 people or a non-profit organization.

20. The method of claim 19, wherein the non-profit organization is a university.

21. The method of claim 2, wherein the exclusive right holder agrees to prosecute potential infringers of the patent.

22. The method of claim 2, wherein said right to a patent granted on the United States application is an exclusive license.

23. The method of claim 2, wherein said right to a patent granted on the United States application is an assignment.

24. The method of claim 2, wherein said right to prosecute a United States application claiming the invention is a right to file and prosecute a single patent application or multiple patent applications related to the invention at the United States Patent and Trademark Office.

25. The method of claim 2, wherein the exclusive right holder pays substantially all of the cost of prosecuting the United States application at the United States Patent and Trademark Office.

26. The method of claim 2, wherein the royalty payment comprises money.

27. The method of claim 2, wherein the royalty payment comprises a license to a patent granted or assigned to a party other than the inventive entity.

28. The method of claim 2, further wherein the inventive entity first files a PCT application and subsequently the inventive entity or exclusive right holder files a United States provisional application within 12 months after filing the PCT application containing substantially the same disclosure as that of the PCT application but without claiming priority from the PCT application.

29. The method of claim 2, wherein the exclusive right holder enforces the patent against a potential infringer without an approval of the inventive entity.

30. The method of claim 2, wherein the method is implemented at least partially under a program of an agency that provides funds to promote patenting of inventions from foreign countries.
